(19) United States
(12) Patent Application Publication
(10) Pub. No.: US 2025/0252541 A1
(43) Pub. Date: Aug. 7, 2025

(54) Data Processing Method, Program, Image Processing Device, and Scanning Probe Microscope

(71) Applicant: SHIMADZU CORPORATION, Kyoto-shi (JP)

(72) Inventors: Masato HIRADE, Kyoto-shi (JP); Keita FUJINO, Kyoto-shi (JP); Kenji YAMASAKI, Kyoto-shi (JP); Kotomi KURODA, Kyoto-shi (JP)

(21) Appl. No.: 18/854,468

(22) PCT Filed: Feb. 1, 2023
(86) PCT No.: PCT/JP2023/003162

§ 371 Date: Jan. 3, 2025

(30) Foreign Application Priority Data
Apr. 7, 2022 (JP) 2022-063826

(51) Int. Cl. G06T 5/73; G06T 7/12; G06T 7/136; G06T 7/194; G06T 11/40

(52) U.S. Cl. CPC G06T 5/73; G06T 7/12; G06T 7/136; G06T 7/194; G06T 11/40; G06T 2207/10056; G06T 2207/20192

(57) ABSTRACT

A computer (132) obtains image data (step S10), extracts from the image data as an edge pixel a pixel satisfying a condition that a result of comparing with an adjacent pixel is an edge (step S12), and generates first data by dilating an edge including the edge pixel (step S14). Then, the computer (132) uses the first data to generate second data that determines a region in a sample corresponding to a substrate (step S22).

### TECHNICAL FIELD

The present invention relates to processing an image obtained through a scanning probe microscope.

### BACKGROUND ART

A scanning probe microscope (SPM) causes a sufficiently sharpened probe to sufficiently approach a sample to be observed and causes the probe to ascend and descend in level so that a fixed physical quantity acts on the tip of the probe and a surface of the sample, while scanning the surface of the sample with the probe in a horizontal direction to observe irregularities on the surface of the sample with high resolution. SPM is a generic term for microscopes used to observe irregularities on a surface of a sample by the above-described principle of operation, and typical SPMs include a scanning tunneling microscope (STM) detecting a current flowing between a probe and a sample as an interaction, and an atomic force microscope (AFM) detecting an atomic force acting between a probe and a sample as an interaction.

The scanning probe microscope has a high resolution in a direction of a height of a surface, and it is difficult to set a sample to have a surface horizontally with the level of the resolution. Accordingly, in general, a height image obtained through the scanning probe microscope (hereinafter referred to as an SPM image) undergoes height correction to correct an inclined surface to be horizontal. Providing a thus corrected image instead of the SPM image allows the user to recognize a state of the surface of the sample more accurately.

As an example of processing an image obtained through such a scanning probe microscope, Japanese Patent Application Laying-Open No. 2019-164090 (PTL 1) describes correction in height of measurement data. More specifically, PTL 1 discloses a technique of extracting at least a portion of a region other than an edge in image data as a reference plane region and correcting measurement data in height based on height information of three points belonging to the reference plane region. According to such a technique, when a sample is a substrate including a structure, and an edge of the structure is accurately detected, three points used for processing an image belong to a region corresponding to the substrate. That is, three points selected from the region corresponding to the substrate are used for processing the image.

### CITATION LIST

### Patent Literature

PTL 1: Japanese Patent Laying-Open No. 2019-164090

### SUMMARY OF INVENTION

### Technical Problem

The above-described technique may not detect an edge of a structure accurately. In such a case, an SPM image cannot be corrected accurately, and a state of a surface of a sample cannot be provided to the user accurately.

The present invention has been made in view of the above circumstances and contemplates providing a technique for providing a state of a surface of a sample to a user accurately.

### Solution to Problem

According to an aspect of the present disclosure, a data processing method is a method for processing image data of a sample including a substrate and a structure on the substrate, the image data being generated based on measurement through a scanning probe microscope, the method comprising: obtaining the image data; extracting from the image data as an edge pixel a pixel satisfying a condition that a result of comparing with an adjacent pixel is an edge; generating first data by applying dilation to the image data to dilate the edge including the edge pixel; and generating second data using the first data to determine a region in the sample corresponding to the substrate.

According to an aspect of the present disclosure, a program causes a computer to perform the data processing method described above.

According to an aspect of the present disclosure, an image processing apparatus performs the data processing method described above. According to an aspect of the present disclosure, a scanning probe microscope comprises the image processing apparatus described above.

### Advantageous Effects of Invention

According to an aspect of the present disclosure, a technique is provided for providing a state of a surface of a sample to a user accurately.

### BRIEF DESCRIPTION OF DRAWINGS

FIG. 1 schematically shows a configuration of a scanning probe microscope according to a first embodiment.

FIG. 2 shows an example of a shape of a sample observed through the scanning probe microscope.

FIG. 3 is a graph representing a height along a line Y1-Y1 indicated in FIG. 2.

FIG. 4 shows another example of a shape of a sample observed through the scanning probe microscope.

FIG. 5 is a graph representing a height along a line Y2-Y2 indicated in FIG. 4.

FIG. 6 schematically shows a result of edge extraction for an image obtained as an observation result through the scanning probe microscope.

FIG. 7 schematically shows a result of dilating an extracted edge.

FIG. 8 schematically shows a result of binarization.

FIG. 9 schematically shows a result of filling holes.

FIG. 10 is a diagram for schematically illustrating a data configuration of a substrate region.

FIG. 11 is a diagram schematically showing a part of an inclination correcting process in a scanning probe microscope 1.

FIG. 12 is a diagram schematically showing a part of the inclination correcting process in scanning probe microscope 1.

FIG. 13 is a flowchart of an example of a process performed in scanning probe microscope 1 for image processing.

FIG. 14 is a flowchart of an example of a process performed in scanning probe microscope 1 according to a second embodiment.

FIG. 15 is a flowchart of an example of a process performed in scanning probe microscope 1 according to a third embodiment.

### DESCRIPTION OF EMBODIMENTS

Embodiments of the present invention will now be described in detail with reference to the drawings. In the figures, identical or equivalent components are identically denoted and will not be described repeatedly.

### First Embodiment

### Schematic Configuration of Scanning Probe Microscope

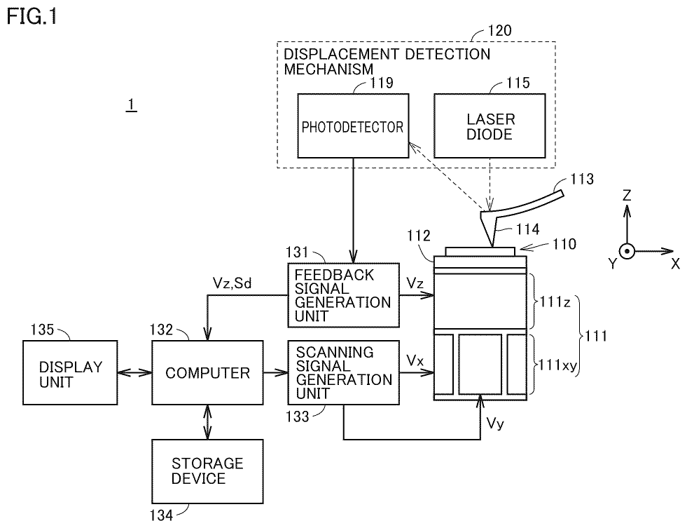

FIG. 1 schematically shows a configuration of a scanning probe microscope according to a first embodiment. One example of the scanning probe microscope is an atomic force microscope. The scanning probe microscope may be another type of scanning probe microscope (for example, a scanning tunneling microscope).

Referring to FIG. 1, scanning probe microscope 1 comprises a sample stage 112 to receive a sample 110 thereon, a piezo scanner 111 that displaces the sample stage, a cantilever 113 having a tip with a probe 114, a displacement detection mechanism 120 that detects that cantilever 113 is displaced, a feedback signal generation unit 131, a computer 132, a scanning signal generation unit 133, a storage device 134, and a display unit 135. In one implementation, computer 132 includes at least one processor, and storage device 134 stores in a non-transitory (non-volatile) manner a program to be executed by the processor.

Piezo scanner 111 includes a Z scanner 111z that causes displacement in the Z direction based on a voltage value Vz, and an XY scanner 111xy that causes displacement in the XY direction based on voltage values Vx and Vy.

Displacement detection mechanism 120 includes a laser diode 115 and a photodetector 119. In scanning probe microscope 1, when the tip of probe 114 is close to sample 110 to observe a surface, laser diode 115 emits a laser beam of light which is in turn reflected by a back surface of cantilever 113 and received by photodetector 119. As probe 114 is closer to the surface of sample 110, cantilever 113 is bent as a leaf spring is, and an amount by which the cantilever is bent is observed at a light receiving location of photodetector 119.

Feedback signal generation unit 131 receives a detection signal from photodetector 119. Based on the detection signal, feedback signal generation unit 131 calculates the amount by which cantilever 113 is bent. Feedback signal generation unit 131 controls the sample positionally in the Z direction so that an atomic force between probe 114 and the surface of sample 110 is constantly fixed. Based on the amount by which cantilever 113 is bent, feedback signal generation unit 131 calculates voltage value Vz to displace piezo scanner 111 in the Z-axis direction, and outputs voltage value Vz to Z scanner 111z.

Scanning signal generation unit 133 calculates voltage values Vx and Vy for the X-and Y-axis directions so that sample 110 moves relative to probe 114 in the X-Y plane in accordance with a predetermined scanning pattern, and scanning signal generation unit 133 outputs the calculated voltage values to XY scanner 111xy.

A signal reflecting an amount of feedback in the Z-axis direction (voltage Vz applied to the scanner and a deviation signal Sd) is also sent to computer 132 and stored in storage device 134. Based on correlation information indicating a relationship between voltage Vz previously stored in storage device 134 and an amount corresponding thereto by which sample 110 has a surface displaced by irregularities thereof, computer 132 calculates from voltage Vz an amount by which sample 110 has a surface displaced by irregularities thereof. Computer 132 calculates amounts of such displacement at locations in the X-and Y-axis directions to reproduce a three-dimensional image of the surface of the sample, and renders the image on a screen of display unit 135. Data of the three-dimensional image is also stored in storage device 134. The data includes coordinates indicating a location on the X-Y plane and a height of the sample at the coordinates. Computer 132 can at any time read the data of the three-dimensional image stored in storage device 134 and cause display unit 135 to display the data.

Computer 132 can correct the data of the three-dimensional image in height, as necessary, and cause display unit 135 to display the data.

### Example of Ideal Observation

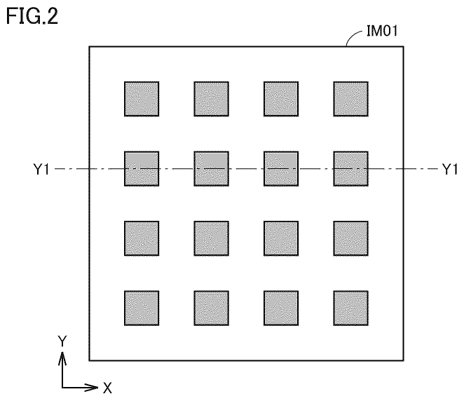

FIG. 2 shows an example of a shape of a sample observed through a scanning probe microscope. Sample 110 corresponding to an image IM01 shown in FIG. 2 includes a substrate and 16 structures disposed on the substrate. The 16 structures are arranged in four rows in the X-axis direction and in four rows in the Y-axis direction, that is, in a state of 4×4. One example of the substrate is a mica plate. One example of the structure is a nanoparticle or nanofiber of a biological sample. Note that these are only an example, and a sample (a substrate and a structure) to be observed through scanning probe microscope 1 is not limited thereto.

Image IM01 has pixels shaded to represent height in the Z-axis direction. A dark pixel represents a higher level of the sample in the Z-axis direction. A light pixel represents a lower level of the sample in the Z-axis direction.

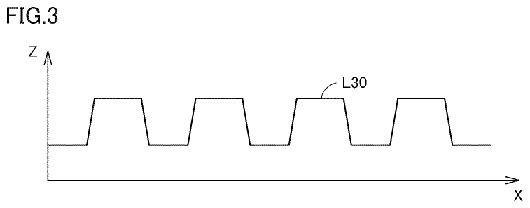

FIG. 3 is a graph representing a height along a line Y1-Y1 indicated in FIG. 2. In the graph of FIG. 3, a line L30 represents a height generated based on ideal observation through scanning probe microscope 1. More specifically, line L30 represents one line of image data observed in an ideal case in which there is no inclination of the substrate in the sample.

While image IM01 of FIG. 2 indicates a plane boundary (a boundary portion between the substrate and the structure) by a line, FIG. 3 shows a plane boundary portion tapered so as to be close to the actual shape of the sample in order to facilitate understanding a correction process. The horizontal axis represents location in the X direction, and the Z axis represents height at each X location. When the probe scans in the X direction, the X axis also corresponds to a time axis.

### Example of Observation in State with Sample Inclined

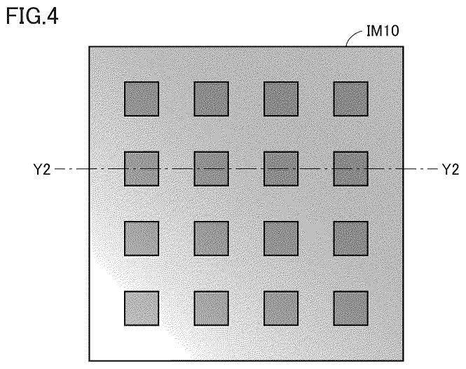

FIG. 4 shows another example of a shape of a sample observed through the scanning probe microscope. FIG. 4 shows an image IM10, which corresponds to the same sample as sample 110 corresponding to image IM01 shown in FIG. 2. Image

IM10 is shaded in a single plane. In image IM10, in particular, a region other than a region corresponding to the 16 structures (i.e., a region corresponding to the substrate) is significantly shaded. One reason for which such shading is caused is that sample 110 is inclined on sample stage 112.

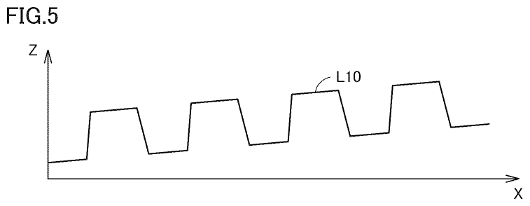

FIG. 5 is a graph representing a height along a line Y2-Y2 indicated in FIG. 4. In FIG. 5, a line L10 represents a height of sample 110 assumed from line Y2-Y2 for image IM10. Line L10 indicates that a surface of sample 110 is inclined so that the surface of sample 110 is higher for a larger X coordinate.

Scanning probe microscope 1 applies a correction to an image generated based on an observation result such as image IM10 to provide a corrected image. Thus, a state of the surface of sample 110 is more accurately recognized from the corrected image. Hereinafter, the correction applied to the image will specifically be described.

### Edge Extraction

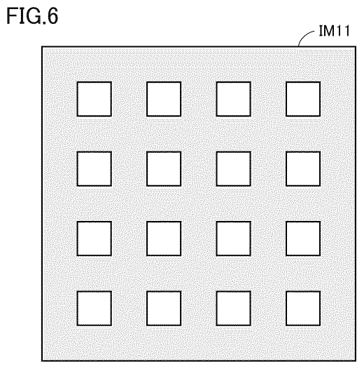

FIG. 6 schematically shows a result of edge extraction for an image obtained as an observation result through the scanning probe microscope. In one implementation, an image IM11 shown in FIG. 6 is obtained by subjecting image IM10 to a known processing for edge extraction (e.g., Process/Find Edges in the open source ImageJ (https://imagej.nih.gov/ij/)).

The processing for extracting an edge to obtain image IM11 typically includes differentiating a height image. Further, the processing for extracting an edge may employ a contour extraction technique generally used in photography processing technology or the like. In one example, a portion having a difference from an adjacent pixel data, the difference having an absolute value exceeding a threshold value, may be extracted.

In image IM11, for the 16 structures, a pixel configuring a boundary of each structure with the substrate is detected as an edge and indicated as a black pixel. When this is done, each pixel detected as an edge is an example of an edge pixel.

### Edge Dilation

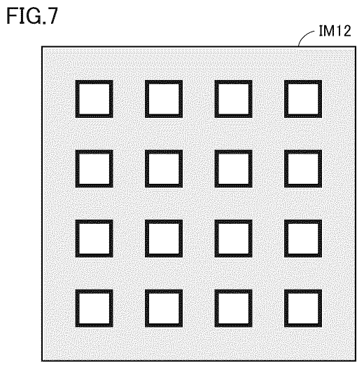

FIG. 7 schematically shows a result of dilating an extracted edge. In one implementation, an image IM12 shown in FIG. 7 is obtained by applying a maximum operation to image IM11 of FIG. 6.

In image IM11 of FIG. 6, an edge pixel is shown as a black pixel (a pixel having a relatively high pixel value). Therefore, by subjecting image IM11 to the maximum operation, in image IM12 shown in FIG. 7, an edge including an edge pixel dilates. Data for displaying image IM12 is an example of “first data”.

Note that the processing for edge dilation is not limited to the maximum operation. The type of the processing for edge dilation can be changed, as appropriate, depending on the manner of representing an edge pixel or the like. For example, when an edge pixel is represented as a white pixel (or a pixel having a relatively low pixel value), a minimum operation may be employed as the processing for edge dilation.

### Binarization

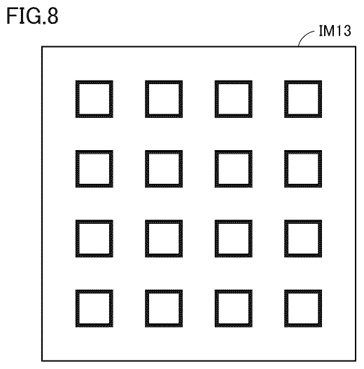

FIG. 8 schematically shows a result of binarization. In one implementation, an image IM13 shown in FIG. 8 is obtained by applying a known binarization process (e.g., Process/Binary/Make Binary in the open source ImageJ (https://imagej.nih.gov/ij/)) to image IM12 of FIG. 7. A threshold for the binarization may be adjusted by the user and/or computer 132, as appropriate.

In image IM13 shown in FIG. 8, a portion of sample 110 corresponding to an end portion corresponding to a respective one of the 16 structures is represented by a black pixel, and any other portion is represented by a white pixel.

### Closing

Computer 132 may apply closing to the binarized image IM13. As a result, an edge pixel detected in image IM10 comes to more accurately represent an outer edge of the structure. Closing can be implemented for example by a known technique (e.g., Process/Binary/Close in the open source ImageJ (https://imagej.nih.gov/ij/)).

### Filling Holes

Computer 132 may apply a hole filling process to the binarized image IM13 (or an image obtained by applying closing to image IM13.).

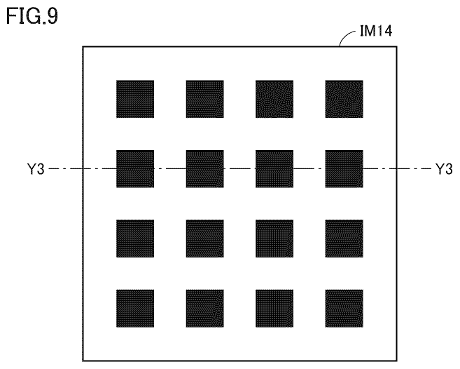

FIG. 9 schematically shows a result of filling holes. The hole filling process can be implemented for example by a known technique (e.g., Process/Binary/Fill Holes, in the open source ImageJ (https://imagej.nih.gov/ij/)).

In an image IM14 shown in FIG. 9, a region in sample 110 corresponding to a respective one of the 16 structures is represented by being filled with black pixels, and any other region is represented by being filled with white pixels.

### Substrate Region

Computer 132 can extract a region of white pixels from image IM14 shown in FIG. 9 as a region in the sample corresponding to the substrate (a region with no structure placed thereon). Data specifying the region corresponding to the substrate (a substrate region) is also referred to as “second data”.

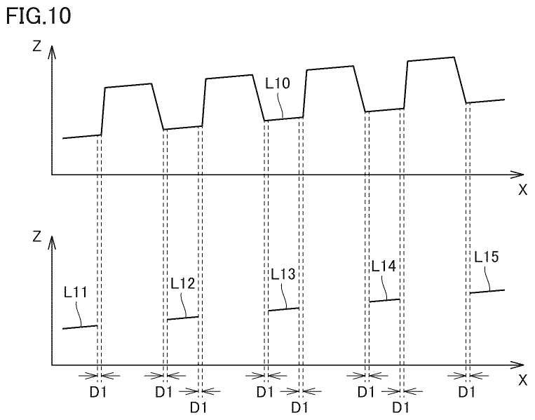

FIG. 10 is a diagram for schematically illustrating a data configuration of the substrate region. FIG. 10 includes lines L11, L12, L13, L14, and L15 indicating a height of the substrate region along a line Y3-Y3 indicated in FIG. 9.

FIG. 10 further indicates line L10 indicated in FIG. 5 as a comparison. Lines L11 to L15 have their respective end portions located inward of a portion of line L10 corresponding to the substrate by a length D1. This corresponds to the substrate region being identified as a region other than a region determined by an edge detected for the structure and dilated. That is, scanning probe microscope 1 dilates an edge of a structure to determine the structure's region to be somewhat broad to thereby ensure that the structure is excluded from the substrate region.

### Correction of Inclination

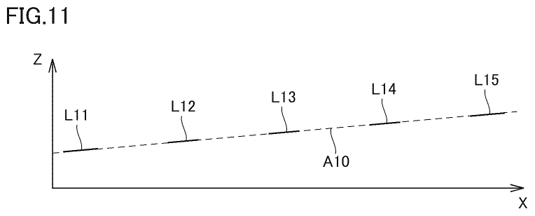

FIG. 11 is a diagram schematically showing a part of an inclination correcting process in scanning probe microscope 1. In FIG. 11, data filling (or interpolated) in order to make lines L11 to L15 indicated in FIG. 10 a single line is indicated by a broken line. A line formed by the data interpolation is indicated as a line A10.

In one implementation, computer 132 in the data interpolation generates a straight line (line A10) inferred from points configuring lines L11 to L15. The generation of the straight line is one example of generation of data for filling. Then, computer 132 implements data interpolation by filling portions other than the five lines L11 to L15 with data of portions of the generated straight line corresponding thereto.

Computer 132 applies data interpolation similar to that shown in FIG. 11 (i.e., generating data for filling, and filling with the data) to the entirety of the data of the substrate region (not only line Y3-Y3 in FIG. 9 but also a region other than that). This generates data corresponding to the region of the entirety of the sample, that is, data representing a plane of the substrate corresponding to the region of the entire sample. The data generated herein virtually represents the substrate in a state with the structure removed from the sample, and is an example of “third data”. An inclination of the plane generated herein is expected to represent an inclination of sample 110 on sample stage 112.

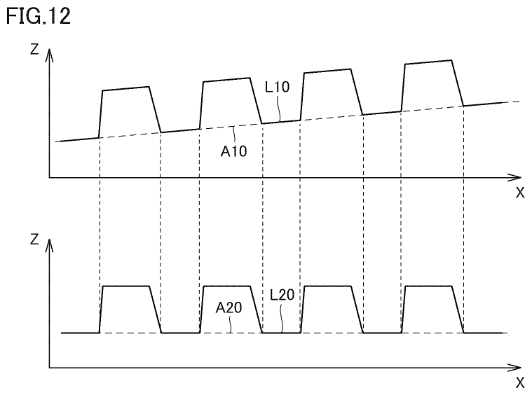

FIG. 12 is a diagram schematically showing a part of the inclination correcting process in scanning probe microscope 1. Computer 132 calculates an inclination of a plane of the data generated in the step described with reference to FIG. 11 relative to an ideal plane, and corrects image IM10 so as to correct the calculated inclination.

In FIG. 12, the orientation of the plane of the data generated in the step described with reference to FIG. 11 is represented as line A10. The ideal plane has an orientation, as indicated by a line A20. Computer 132 calculates an inclination of line A10 relative to line A20. This inclination corresponds to the inclination of sample 110. Then, computer 132 corrects image IM10 (see FIG. 4) so as to cancel the calculated inclination. This correction generates a line L20 from line L10, as shown in FIG. 12. Similarly, image IM10 has its entire area corrected to generate a corrected image. This correction is expected to bring image IM10 closer to image IM01 (see FIG. 2). In the present specification, the corrected image is also referred to as “fourth data”.

### Process Flow

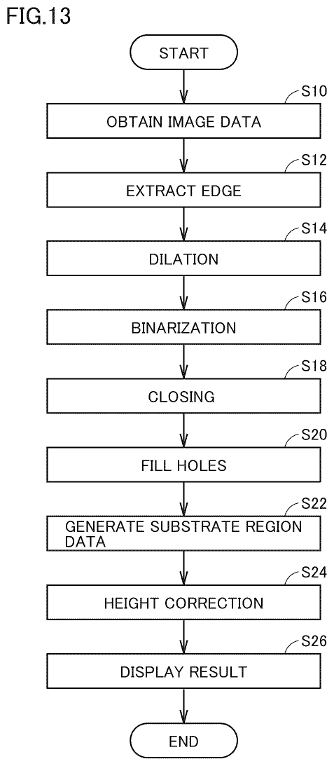

FIG. 13 is a flowchart of an example of a process performed in scanning probe microscope 1 for image processing. In one implementation, the FIG. 13 process is implemented by a processor of computer 132 executing a given program. In this sense, computer 132 is an example of an image processing apparatus.

In step S10, scanning probe microscope 1 obtains image data as an observation result. One example of the image data obtained herein corresponds to image IM10 of FIG. 4.

In step S12, scanning probe microscope 1 extracts an edge for the image obtained in step S10. The extraction of the edge is implemented for example by the technique described with reference to FIG. 6.

In step S14, scanning probe microscope 1 dilates the edge extracted in step S12. The dilation of the edge is implemented for example by the technique described with reference to FIG. 7.

In step S16, scanning probe microscope 1 binarizes the image having the edge dilated in step S14. The binarization is implemented for example by the technique described with reference to FIG. 8.

In step S18, scanning probe microscope 1 applies closing to the image binarized in step S16. Closing is implemented for example by the technique described with reference to FIG. 9.

In step S20, scanning probe microscope 1 applies hole filling to the image subjected to closing in step S18. Hole filling is implemented for example by the technique described with reference to FIG. 9.

In step S22, scanning probe microscope 1 generates substrate region data using the image subjected to hole filling in step S20. The substrate region data is data specifying a substrate region, and is the above-described “second data”.

In step S24, scanning probe microscope 1 uses the second data to correct the image data obtained in step S10 (or correct height). The correction of the image data is implemented for example by the technique described with reference to FIGS. 11 and 12.

The technique described with reference to FIGS. 11 and 12 fills the data specifying the substrate region with data in a region corresponding to a structure, as indicated in FIG. 11 by a broken line (or line A10). Note that the correction of the image data may dispense with such data filling. Scanning probe microscope 1 may calculate an inclination of sample 110 (relative to an ideal plane) from the substrate region alone.

In step S26, scanning probe microscope 1 causes display unit 135 to display a processing result. The displayed result may include an image generated by the correction performed in step S24. Thereafter, scanning probe microscope 1 ends the FIG. 13 process.

In the first embodiment described above, first data is generated by dilating an edge of a structure, and the first data is used to generate second data specifying a region in a sample corresponding to a substrate (a region having no structure on the substrate). This ensures that the region specified by the second data and corresponding to the substrate excludes an image of the structure. Furthermore, a region other than the region is also determined as a region including the entirety of the structure.

When the region specified by the second data is utilized to correct an inclination in original image data that is caused by an inclination of the sample, more points (or lines or regions) can be utilized for the correction. This allows the correction to be done to correct the inclination more accurately. This can provide the user with a state of a surface of the sample accurately.

### Second Embodiment

In a second embodiment, scanning probe microscope 1 uses substrate region data to correct original image data, and from the corrected image data again determines a region corresponding to a structure.

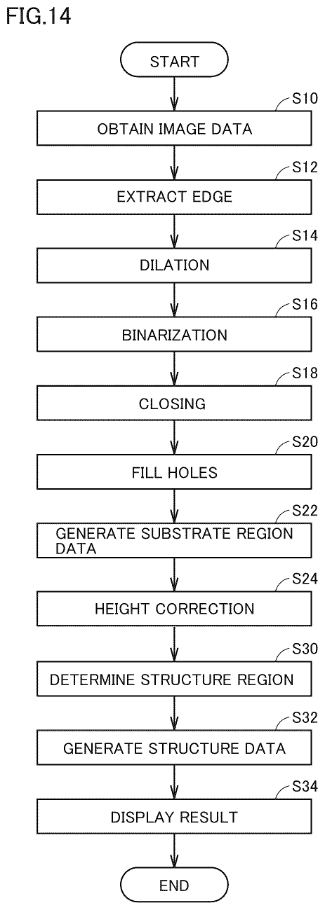

FIG. 14 is a flowchart of an example of a process performed in scanning probe microscope 1 according to the second embodiment.

As well as the FIG. 13 process, the FIG. 14 process includes controlling steps S10 to S24. In the FIG. 14 process, after step S24, the control proceeds to step S30.

In step S30, scanning probe microscope 1 determines a region corresponding to a structure in the corrected image data generated in step S24. The corrected image data generated in step S24 is an example of “fourth data”.

Determining a region corresponding to a structure in step S30 may for example include the same control as steps S12 to S22. That is, scanning probe microscope 1 extracts an edge for the corrected image data, dilates the extracted edge, binarizes the image having the edge dilated, applies closing to the binarized image, applies hole filling to the image subjected to closing, and generates substrate region data for the image subjected to hole filling. Then, scanning probe microscope 1 determines a region other than a substrate region determined by the substrate region data as a region corresponding to the structure.

In step S32, scanning probe microscope 1 generates “structure data” by extracting the region corresponding to the structure determined in step S30 from the corrected image data obtained in step S24. The structure data includes an image corresponding to the structure.

In step S34, scanning probe microscope 1 causes display unit 135 to display a processing result. The displayed result may include an image for the structure data generated in step S30, i.e., the image corresponding to the structure. Thereafter, scanning probe microscope 1 ends the FIG. 14 process.

In the second embodiment described above, a region other than the region specified by the second data is extracted from original image data and displayed as structure data. The second data is generated using the first data, and the first data is generated through dilation. This ensures that the region other than the region specified by the second data includes the entire region of the structure. Thus, a state of the structure and hence a state of a surface of the sample can be provided to the user accurately.

### Third Embodiment

In a third embodiment, scanning probe microscope 1 generates an image of the entirety of a sample in a pseudo manner by combining the structure data of the second embodiment with data filling the region of the substrate for a background.

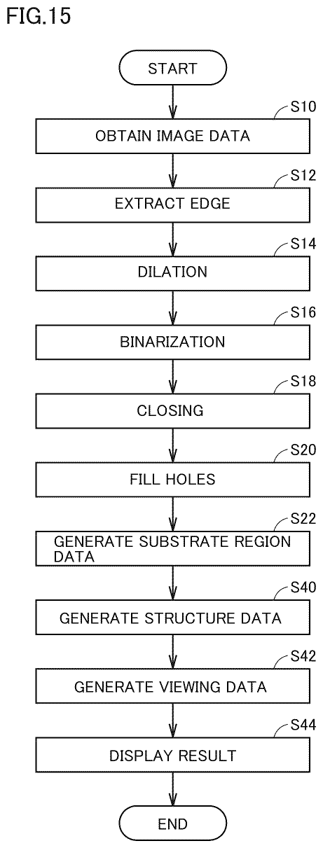

FIG. 15 is a flowchart of an example of a process performed in scanning probe microscope 1 according to the third embodiment.

As well as the FIG. 13 process, the FIG. 15 process includes controlling steps S10 to S22. In the FIG. 15 process, after step S22, the control proceeds to step S40.

In step S40, scanning probe microscope 1 generates structure data using the image data obtained in step S10 and the substrate region data generated in step S22. The structure data generated in step S40 is generated by extracting from the image data obtained in step S10 a region other than the region of the substrate specified by the substrate region data generated in step S22.

In step S42, scanning probe microscope 1 generates viewing data by filling a region other than the region specified by the structure data generated in step S40 with data for a background. The viewing data represents an image of the entirety of the sample in a pseudo manner. In this image, a structure in the image data obtained in step S10 is combined with an image for the background.

In step S44, scanning probe microscope 1 causes display unit 135 to display a processing result. The displayed result may include an image for the viewing data generated in step S42, i.e., an image of the entirety of the sample in a pseudo manner. Thereafter, scanning probe microscope 1 ends the FIG. 14 process.

In the image for the viewing data (the image of the entirety of the sample in a pseudo manner) according to the third embodiment, a region corresponding to the substrate region has an appropriate level of brightness, and thus it is unnecessary to adjust contrast when displaying the image for the viewing data. Therefore, the user can visually recognize a processing result without requiring a cumbersome operation such as adjustment of contrast. In conventional art, in adjustment of contrast, a wave in pixel density may be caused in a background. The third embodiment can dispense with adjustment of contrast and thus avoid such a wave in pixel density as described above otherwise caused in an image displayed to the user. The viewing data may be generated by combining the structure data generated in the second embodiment (S30) with the data for the background (S42).

The image of the entirety of the sample in a pseudo manner as described above includes an image of a region other than the region specified by the second data from original image data. The second data is generated using the first data, and the first data is generated through dilation. This ensures that the region other than the region specified by the second data includes the entire region of the structure. Thus, by providing an image of the entirety of the sample in a pseudo manner, a state of the structure and hence a state of a surface of the sample can be provided to the user accurately.

### Aspects

It will be understood by those skilled in the art that the exemplary embodiments described above are specific examples of the following aspects.

(Clause 1) In one aspect, a data processing method is a method for processing image data of a sample including a substrate and a structure on the substrate, the image data being generated based on measurement through a scanning probe microscope, and may comprise the steps of: obtaining the image data; extracting from the image data as an edge pixel a pixel satisfying a condition that a result of comparing with an adjacent pixel is an edge; generating first data by applying dilation to the image data to dilate the edge including the edge pixel; and generating second data using the first data to determine a region in the sample corresponding to the substrate.

The data processing method according to clause 1 provides a technique for providing a user with a state of a surface of a sample accurately.

(Clause 2) The data processing method according to clause 1, wherein the dilation may include a maximum operation.

The data processing method according to clause 2 ensures that, in dilation, a configuration is dilated by an edge pixel. (Clause 3) The data processing method according to clause 1 or 2 may further

comprise generating from the image data third data representing an image of the substrate alone by filling a region other than the region determined by the second data with filling data.

The data processing method according to clause 3 can correct original image data in height more accurately.

(Clause 4) The data processing method according to clause 3, wherein the step of generating third data may include generating the filling data using a pixel value of the region determined by the second data in the image data.

The data processing method according to clause 4 can generate filling data to be more suitable for the original image data.

(Clause 5) The data processing method according to clause 3 or 4, wherein the step of generating third data may include generating fourth data by applying inclination correction to the image data using the third data.

The data processing method according to clause 5 can more reliably generate image data having inclination corrected as the fourth data.

(Clause 6) The data processing method according to clause 5 may further comprise: determining in the fourth data a region in the image data corresponding to the structure; and generating structure data from the image data, the structure data being the determined region in the image data corresponding to the structure.

The data processing method according to clause 6 can more reliably generate data including the entirety of the structure as structure data.

(Clause 7) The data processing method according to clause 1 or 2 may further comprise generating structure data from the image data by extracting the region determined by the second data.

The data processing method according to clause 7 can more reliably generate data including the entirety of the structure as structure data.

(Clause 8) The data processing method according to clause 6 or 7 may further comprise generating viewing data by combining the structure data with background data having a pixel for a background in the region determined by the second data.

The data processing method according to clause 8 dispenses with adjustment of contrast when displaying viewing data.

(Clause 9) The data processing method according to any one of clauses 1 to 8 may further comprise applying binarization to the first data or data resulting from the first data to generate the second data.

The data processing method according to clause 9 can represent an edge in data more prominently.

(Clause 10) The data processing method according to clause 9 may further comprise applying closing to the binarized image to generate the second data.

The data processing method according to clause 10 more reliably determines a region corresponding to the substrate in data.

(Clause 11) In one aspect, a program may cause a computer to perform the data processing method according to any one of clauses 1 to 10.

The program according to clause 11 provides a technique for providing a user with a state of a surface of a sample accurately.

(Clause 12) In one aspect, an image processing apparatus performs the data processing method according to clauses 1 to 10.

The image processing apparatus according to clause 12 provides a technique for providing a user with a state of a surface of a sample accurately.

(Clause 13) In one aspect, a scanning probe microscope may comprise the image processing apparatus according to clause 12.

The scanning probe microscope according to clause 13 provides a technique for providing a user with a state of a surface of a sample accurately.

It should be understood that the embodiments disclosed herein are illustrative and non-restrictive in any respect. The scope of the present disclosure is defined by the terms of the claims rather than by the foregoing description of the embodiments and is intended to encompass any modifications within the meaning and scope equivalent to the terms of the claims. It is also contemplated that each technique in the embodiments may be implemented alone or in combination with other techniques in the embodiments as much as possible, as necessary.

### REFERENCE SIGNS LIST

1 scanning probe microscope, 110 sample, 111 piezo scanner, 111xy XY scanner, 111z Z scanner, 112 sample stage, 113 cantilever, 114 probe, 115 laser diode, 119 photodetector, 120 displacement detection mechanism, 131 feedback signal generation unit, 132 computer, 133 scanning signal generation unit, 134 storage device, 135 display unit.

1. A method for processing image data of a sample including a substrate and a structure on the substrate, the image data being generated based on measurement through a scanning probe microscope, the method comprising:
obtaining the image data;
extracting a first substrate region from the image data, the first substrate region being a region corresponding to the substrate;
extracting a structure region from the image data, the structure region being a region corresponding to the structure;
extracting from the image data as an edge pixel a pixel satisfying a condition that a result of comparing with an adjacent pixel is an edge;
determining an edge dilated region by applying dilation to the image data to dilate the edge including the edge pixel;
generating second data by removing the edge dilated region and the structure region from the first substrate region; and
calculating an inclination using the second data.

2. The data processing method according to claim 1, wherein the dilation includes a maximum operation.

3. The data processing method according to claim 1, further comprising: generating from the image data third data representing an image of the substrate alone by filling a region other than the region determined by the second data with filling data.

4. The data processing method according to claim 3, wherein the generating third data includes generating the filling data using a pixel value of the region determined by the second data in the image data.

5. The data processing method according to claim 3, wherein the generating third data includes generating fourth data by applying inclination correction to the image data using the third data.

6. The data processing method according to claim 5, further comprising:
determining in the fourth data a region in the image data corresponding to the structure; and
generating structure data from the image data, the structure data being the determined region in the image data corresponding to the structure.

7. The data processing method according to claim 1, further comprising generating structure data from the image data by extracting the region determined by the second data.

8. The data processing method according to claim 6, further comprising generating viewing data by combining the structure data with background data having a pixel for a background in the region determined by the second data.

9. The data processing method according to claim 1, further comprising applying binarization to data generated by applying the dilation to the image data or data resulting from the thus generated data to generate the second data.

10. The data processing method according to claim 9, further comprising applying closing to the binarized image to generate the second data.

11. A non-transitory computer readable medium storing a program that causes a computer to perform the data processing method according to claim

1.

12. An image processing apparatus that performs the data processing method according to claim 1.

13. A scanning probe microscope comprising the image processing apparatus according to claim 12.

14. The data processing method according to claim 1, further comprising generating filling data complementing data of the first substrate region, wherein the calculating an inclination uses the filling data in addition to the second data
